(19) United States
(12) Patent Application Publication
(10) Pub. No.: US 2008/0199825 A1
(43) Pub. Date: Aug. 21, 2008

(54) Orthodontic bracket

(76) Inventor: Ingolf Jahn, Marburg (DE)

Correspondence Address: Davidson, Davidson & Kappel, LLC, 485 7th Avenue, 14th Floor, New York, NY, 10018, US

(21) Appl. No.: 12/070,410

(22) Filed: Feb. 19, 2008

(30) Foreign Application Priority Data
Feb. 20, 2007 (DE) DE 102007008356.6

(51) Int. Cl. A61C 7/30

(52) U.S. Cl. 433/11

(57) ABSTRACT

In a cube-shaped Bracket the underside of which is attached to a tooth and with a slot in the upper surface forming together with the neighbouring teeth a continual groove an elastic element is incorporated in the slot which is a pair of leaf-shaped springs an archwire can be securely fixed between.

This claims priority to German patent application DE 10 2007 008 356.6, filed Feb. 20, 2007, the entire disclosure of which is incorporated by reference herein.

Orthodontic brackets are familiar as holding/fixing devices with which a wire that describes the ideal arch of a row of teeth is held in place. Via the brackets pressure is applied to the individual teeth that do not correspond to this ideal arch thus helping to correct the faulty position.

As the pressure applied to the teeth cannot be too intense, the strength of the wire is increased step by step. The archwire must be replaced several times during the treatment.

### BACKGROUND

Usually a bracket consists of a metal cube that is fixed on its under side to the outer surface of the teeth. The upper surface of the bracket has a slot which corresponds to the slot in the neighbouring brackets and forms a continual groove.

The cross section of the groove into which the archwire is fitted is generally a right-angle. The archwire is adapted to fit this form making it possible to apply pressure also to the axial inclination of the teeth (torque). This is known as “edgewise technique.” To control and adjust the torque it is necessary to change the thickness of the archwire.

Once the archwire has been fitted into the slot it is secured with the help of elastomeric o-rings or ligature wire. The o-rings or wires are attached to wing-shaped attachments at the side of the slot.

Anchorage of the archwire using this method has disadvantages as it is difficult to achieve the optimal dosage of pressure needed for each individual tooth, the intended correction is thus endangered.

Other brackets have an integrated anchorage. These so-called self-ligating brackets have a locking device which is usually adjustable and hinders the wire from leaving the slot (passive).

In EP 1 235 528 B1 a bracket is described in which the archwire is secured in the slot with several latches whereby the archwire lies on a cushion element on the floor of the slot.

Furthermore, DE 602 14 378 T informs us that the anchorage of the archwire can also be achieved using a protrusion or tongue above the open side of the archwire slot. The other surfaces of the archwire make contact with the appropriate surface within the archwire slot. The application of wires with a sufficient diameter is only possible through the gradual increase of wire sizes. As the correction of the faulty teeth progresses, the insertion into the slot of the wire with the greatest diameter is made possible.

### SUMMARY OF THE INVENTION

It is an object of the present invention to implement the securing device for the archwire in such a way that the fitting and removal of the archwire is simplified and the application of pressure needed for the tooth correction is improved.

In the case of a bracket for orthodontic treatment the underside of which is attached to a tooth and with a slot in the upper surface forming together with the neighbouring teeth a continual groove, the solution to this task is found in at least one elastic element incorporated in the slot and in which the archwire can be securely fixed. The elastic element is a leaf-shaped spring which is allocated to one side wall of the archwire slot. One end of the spring rests on the upper edge of the slot, the other is attached to the floor of the slot.

An application according to the invention allows the use of wire with the maximum diameter at a stage in the treatment when the positioning of the teeth is not yet at an advanced state, in other words much earlier than previously possible. The archwire needs not be replaced when incorrectly positioned teeth are not yet at their intended place because the elastic element is still dislocated. Thus pressure is automatically applied via the brackets until the desired position has been reached.

In addition to this, fitting of the wire to the brackets is simplified considerably so time involved and costs for an orthodontic treatment are significantly reduced. The application of ligature wire or o-rings as well as fixing devices is no longer necessary.

In accordance with a further feature of the invention it is planned that a second identical leaf-shaped spring be allocated to the side wall opposite the above mentioned side wall.

Space for movement exists between the spring and the wall so that the spring remains flexible and adjustable. In the area at the front of the slot the spring is arched parallel to the opposite side surface slot. The curves of the opposing springs form in this way a wedge-shaped gap which opens when an archwire is applied. The archwire, once pressed into the gap, is held firmly by the elements springing back into place. In this way, the archwire is held in the gap without additional devices.

A variation of the invention includes self-securing insertion slots on the outer surface of the bracket which accommodate an appropriately formed bend in the surface of the spring. This increases the resistance counteracting any unintentional displacement of the treatment wire from the slot.

An additional feature of the invention relates to the form of the cross section of the archwire that runs parallel to the inner surface of the slot while the upper surface of the arch-shaped wire is rounded. The advantage of this modification is the optimal fixation as the form of the wire corresponds to the form of the two springs and the slot. As long as one tooth has not yet achieved the intended position, there is a discrepancy between the positioning of the treatment wire and the bracket. Through this discrepancy the springs are forced out of their natural position and exert therefore pressure upon the wire-bracket-tooth system. This is an optimal situation: application of continual and steady pressure is applied to the teeth.

### BRIEF DESCRIPTION OF THE DRAWINGS

Further features and advantages of the invention are illustrated in the drawing of two examples without being limited thereto.

FIG. 1 shows a bracket according to an initial implementation form in cross section view A-A;

FIG. 2. shows a view of an orthodontic bracket as in FIG. 1;

FIG. 3. is a detailed drawing of a bracket in cross section A-A with a secured archwire;

FIG. 4. shows a detailed drawing of a bracket according to a second implementation form with insertion slots in cross section A-A;

FIG. 5. shows a detailed drawing of a bracket as in FIG. 4 with an inserted archwire and open spring;

FIG. 6. shows a detailed drawing of a bracket as in FIG. 4 with an inserted archwire and closed spring

### DETAILED DESCRIPTION

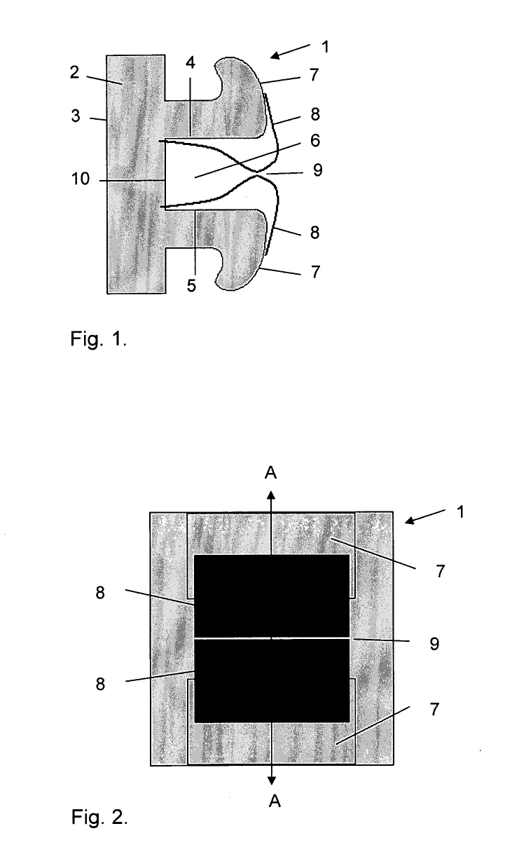

The bracket consists—as FIG. 1 shows—of a cubed-shaped body (1) the basis (2) of which is fixed, usually using adhesive via the lower surface (3) to a tooth which is not shown on the drawing. On the basis (2) are two fixed positioned parallel running side walls (4, 5) that form a slot (6).

The brackets positioned on the row of teeth have a row of slots (6) forming a continual groove (not illustrated). The side walls (4, 5) of the slots (6) are constructed to form out pointing right-angles at their opposing free ends and offer there rounded application surfaces (7) for two identical leave-shaped springs (8). From these application surfaces (7) the two springs (8) are curved forward to the middle of the archwire slot (6) and to a wedge-shaped gap (9). From the gap (9) the distance between the springs (8) and the neighbouring side walls (4, 5) is continually reduced but without these making contact. The springs (8) are secured on the floor (10) of the slot (6).

FIG. 2 shows the two opposite springs (8) with their two ends protruding from the archwire slot (6) supported on the application surfaces (7) and leaving the wedge-shaped gap (9).

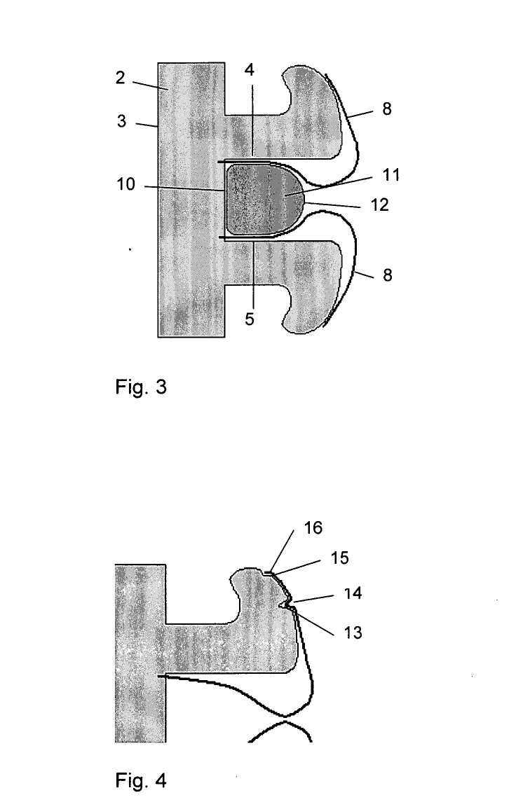

In FIG. 3 an archwire (11) is secured between the springs (8). The side surfaces of the archwire (11) run parallel to the side walls (4, 5) and to the floor (10) of the archwire slot (6). Towards the open side of the archwire slot (6) a side surface is rounded (12). The springs (8) that secure the archwire (11) have enough space in the slot (6) to remain adjustable and removeable.

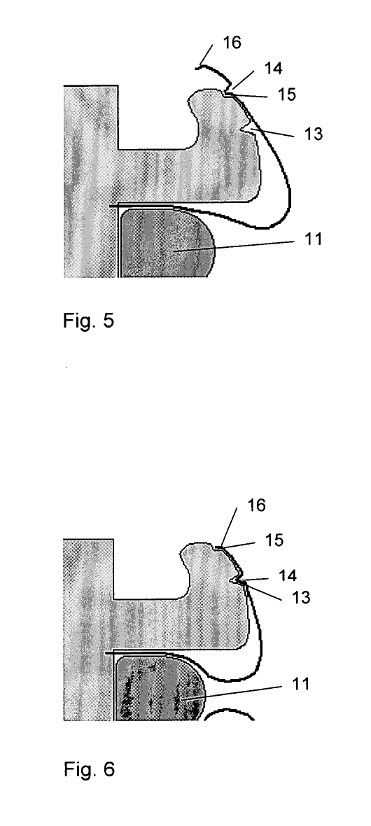

FIG. 4 shows a detailed drawing of a variation of the bracket shown in FIG. 1-3 in which the application surfaces (7) have self-securing insertion slots (13). The springs have a bend (14) which rest in the insertion slots (13) when the device is closed. At the end of the application surface (7) there is a further slot (15) into which the bend can be inserted when the device is open. This holds the spring (8) open (FIG. 5). The open end of the spring (8) is bent towards the inside so that a small surface (16) is left which enables the spring (8) to be changed from the open to the closed condition using finger pressure (FIG. 8).

### List of Terms

1. Bracket
2. Basis
3. Underside
4. Side wall
5. Side wall
6. Archwire slot
7. Application surface
8. Spring
9. Gap
10. Floor of the archwire slot
11. Archwire
12. Rounded surface of the archwire
13. Self-securing insertion slot
14. Slot
15. Bend

What is claimed is:

1. Bracket for orthodontic treatment the underside of which is attached to a tooth and with a slot in the upper surface forming together with the neighbouring teeth's brackets a continual groove thus characterised: that in the archwire slot (6) of the bracket at least one elastic element is incorporated with which an archwire (11) can be flexibly secured, that as a flexible element a leaf-shaped spring is allocated to a side wall (4) of the archwire slot (6) and the spring rests with one end at the upper edge of the slot (6) and is secured with the other end on the floor (10) of the slot (6)

2. Bracket according to claim 1, thus characterised: that the side wall (5) positioned opposite the archwire slot (6) has a second identical leaf-shaped spring (8) allocated, that both springs (8) are curved parallel to the opposite side walls (4, 5) in the upper edge area of the slot (6) and form at the curved section a gap (9).

3. Bracket according to claim 1, thus characterised: that on the outer surface of the bracket self-securing insertion slots (13) are incorporated in which an appropriately formed bend (14) in the application surface (7) of the spring snaps into place and is secured

4. Bracket according to claim 1, thus characterised: that the archwire (11) in cross section is right-angled apart from one side surface (12) on the outer side of the archwire (11), that has a rounded form.
